(19) United States
(12) Patent Application Publication
(10) Pub. No.: US 2006/0129763 A1
(43) Pub. Date: Jun. 15, 2006

(54) Virtual cache for disk cache insertion and eviction policies and recovery from device errors

(76) Inventors: Robert J. Royer JR., Portland, OR (US); Sanjeev N. Trika, Hillsboro, OR (US); Jeanna N. Matthews, Massena, NY (US); John I. Garney, Portland, OR (US); Michael K. Eschmann, Lees Summit, MO (US)

Correspondence Address: TROP PRUNER & HU, PC, 8554 KATY FREEWAY, SUITE 100, HOUSTON, TX, 77024, US

(21) Appl. No.: 11/352,162

(22) Filed: Feb. 10, 2006

Related U.S. Application Data
(62) Division of application No. 10/739,608, filed on Dec. 18, 2003.

(51) Int. Cl. G06F 13/00

(52) U.S. Cl. 711/118; 711/162

(57) ABSTRACT

Processor-based systems may include a disk cache to increase system performance in a system that includes a processor and a disk drive. The disk cache may include physical cache lines and virtual cache lines to improve cache insertion and eviction policies. The virtual cache lines may also be useful when recovering from failed requests.

This application is a divisional of U.S. patent application Ser. No. 10/739,608, filed on Dec. 18, 2003.

### BACKGROUND

Peripheral devices such as disk drives used in processor-based systems may be slower than other circuitry in those systems. The central processing units and the memory devices in systems are typically much faster than disk drives. Therefore, there have been many attempts to increase the performance of disk drives. However, because disk drives are electromechanical in nature there may be a finite limit beyond which performance cannot be increased.

One way to reduce the information bottleneck at the peripheral device, such as a disk drive, is to use a cache. A cache is a memory location that logically resides between a device, such as a disk drive, and the remainder of the processor-based system, which could include one or more central processing units and/or computer buses. Frequently accessed data resides in the cache after an initial access. Subsequent accesses to the same data may be made to the cache instead of the disk drive, reducing the access time since the cache memory is much faster than the disk drive. The cache for a disk drive may reside in the computer main memory or may reside in a separate device coupled to the system bus, as another example.

Disk drive data that is used frequently can be inserted into the cache to improve performance. Data which resides in the disk cache that is used infrequently can be evicted from the cache. Insertion and eviction policies for cache management can affect the performance of the cache. Performance can also be improved by allowing multiple requests to the cache to be serviced in parallel to take full advantage of multiple devices.

### BRIEF DESCRIPTION OF THE DRAWING

FIG. 1 is a block diagram of a processor-based system in accordance with one embodiment of the present invention.

FIG. 2 is a block diagram of a memory device in accordance with one embodiment of the present invention.

FIG. 3A is a flow chart in accordance with one embodiment of the present invention.

FIG. 3B is a flow chart in accordance with one embodiment of the present invention.

FIG. 4 is a block diagram of a memory device in accordance with one embodiment of the present invention.

FIG. 5 is a flow chart in accordance with one embodiment of the present invention.

### DETAILED DESCRIPTION

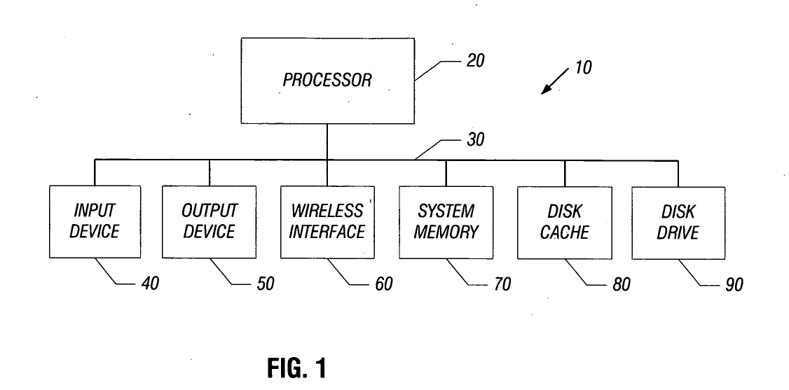

Referring to FIG. 1, a processor-based system 10 may be a computer, a server, a telecommunication device, a consumer electronic system, or any other processor-based system. The processor 20 may be coupled to a system bus 30. The system bus 30 may include a plurality of buses or bridges which are not shown in FIG. 1. The system 10 may include an input device 40 coupled to the processor 20. The input device 40 may include a keyboard or a mouse. The system 10 may also include an output device 50 coupled to the processor 20. The output device 50 may include a display device such as a cathode ray tube monitor, liquid crystal display, or a printer. Additionally, the processor 20 may be coupled to a system memory 70 (which may include read only memory (ROM) and random access memory (RAM)), disk cache 80, and a disk drive 90. The disk drive 90 may be a floppy disk, hard disk, solid state disk, compact disk (CD) or digital video disk (DVD). Other memory devices may also be coupled to the processor 20. In one embodiment, the system 10 may enable a wireless network access using a wireless interface 60, which in an embodiment, may include a dipole antenna.

Disk cache 160, which may include an option read only memory, may be made from a ferroelectric polymer memory. Data may be stored in layers within the memory. The higher the number of layers, the higher the capacity of the memory. Each of the polymer layers includes polymer chains with dipole moments. Data may be stored by changing the polarization of the polymer between metal lines.

Ferroelectric polymer memories are non-volatile memories with sufficiently fast read and write speeds. For example, microsecond initial reads may be possible with write speeds comparable to those with flash memories.

In another embodiment, disk cache 160 may include dynamic random access memory or flash memory. A battery may be included with the dynamic random access memory to provide non-volatile functionality.

In the typical operation of system 10, the processor 20 may access system memory 70 to execute a power on start-up test (POST) program and/or basic input output system (BIOS) program. The processor 20 may use BIOS and/or POST software to initialize the system 10. The processor 20 may then access disk drive 90 to retrieve an operating system software. The system 10 may also receive input from the input device 40 or may run an application program stored in system memory 70 or from a wireless interface 60. System 10 may also display the system 10 activity on the output device 50. The system memory 70 may be used to hold application programs or data that is used by the processor 20. The disk cache 80 may be used to cache data for disk drive 90.

Also in the typical operation of system 10, disk cache 80 may insert or evict data based on disk caching policies. A disk caching policy may include inserting data on a miss or evicting data based on a least recently used statistic. Disk caching policies may be improved if a larger context of data is maintained. A larger context of data may be available by system memory holding metadata but not the actual data. This larger context of metadata may be referred to as a virtual cache having virtual cache lines. A physical cache line may have metadata and physical data whereas a virtual cache line may also have metadata but would not have physical data. Both types of cache lines can reside in system memory or in disk cache. In one example, virtual cache lines in system memory and physical cache lines in disk cache may provide better performance. Virtual cache may be used to facilitate insertion and eviction policies for the physical cache. Since the virtual cache does not store physical data, it may have many more cache lines than the physical disk cache.

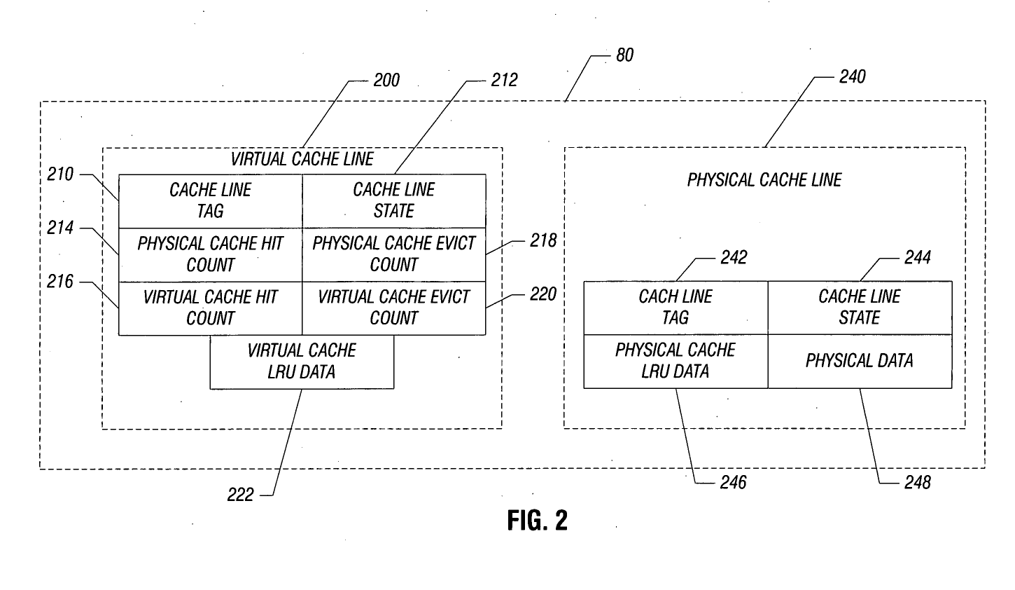

Referring to FIG. 2, a block diagram of a disk cache 80 (FIG. 1) in accordance with one embodiment of the present invention is disclosed. The disk cache 80 may contain one or more physical cache lines and one or more virtual cache lines. In this example, disk cache 80 includes a physical cache line 240 and a virtual cache line 200. In one embodiment, a physical cache line and a virtual cache line may be on a common printed circuit board or semiconductor. However, the disclosed invention is not limited to having physical and virtual cache lines on a common board or semiconductor.

The physical cache line 240 includes a cache line tag 242, a cache line state 244, and a physical cache least recently used (LRU) data 246. The cache line tag 242 may be used to identify a particular cache line to its corresponding data on a disk drive. The cache line state 244 may correspond to data that may be useful for determining if the physical cache line should be evicted, such as the number of hits to the cache line, as an example. The physical cache LRU data 246 may be used to determine when this cache line was last used, which may also be useful for determining if the cache line should be evicted. The physical cache line 240 also includes physical data 248 that is associated with the physical cache line 240 in FIG. 2. Physical data 248 may be one or more disk sectors of data corresponding to the disk location of the cache line. Physical data 248 may be several 512 bytes of data in size, whereas other cache line information may be less than 100 bytes of information.

At least one difference between physical cache line 240 and the virtual cache line 200 is that the physical cache line 240 may include the physical data 248 associated with its cache line tag whereas the virtual cache line 200 may not include physical data. Instead, the virtual cache line 200 may include metadata which may be useful for determining if a cache line should be evicted or inserted into the cache with its data or if a virtual cache line should be evicted, in certain embodiments.

As shown in FIG. 2, virtual cache line 200 may include a cache line tag 210 and a cache line state 212. The cache line tag 210 may be used to identify a particular cache line to its corresponding physical cache line 240. The cache line state 212 may correspond to data that may be useful for determining if the physical cache line 240 should be evicted, such as the number of hits to the cache line, as an example. The virtual cache lines in the virtual cache could include all of the physical cache lines of the physical cache or could contain many more cache lines than those in the physical cache. Virtual cache line 200 may also include a physical cache hit count 214, a virtual cache hit count 216, a physical cache evict count 218, a virtual cache evict count 220 and a virtual cache least recently used data 222.

In various embodiments, the virtual cache line 200 may be used to track state or metadata of each cache line in the disk cache 80 and, in this example, does not contain any user or application data. The number of cache lines contained in the virtual cache may be several times the number of cache lines in the physical cache, but is not limited to any size in this example. In one embodiment, the virtual cache line 200 disclosed in FIG. 2 may improve the performance of applications that thrash a disk cache with traditional caching policies such as insert on miss and least recently used (LRU) for eviction. In another embodiment, the virtual cache line 200 may be used to recognize cache lines that are frequently evicted and inserted into the cache and then modify the caching policies so that these cache lines are not evicted as frequently.

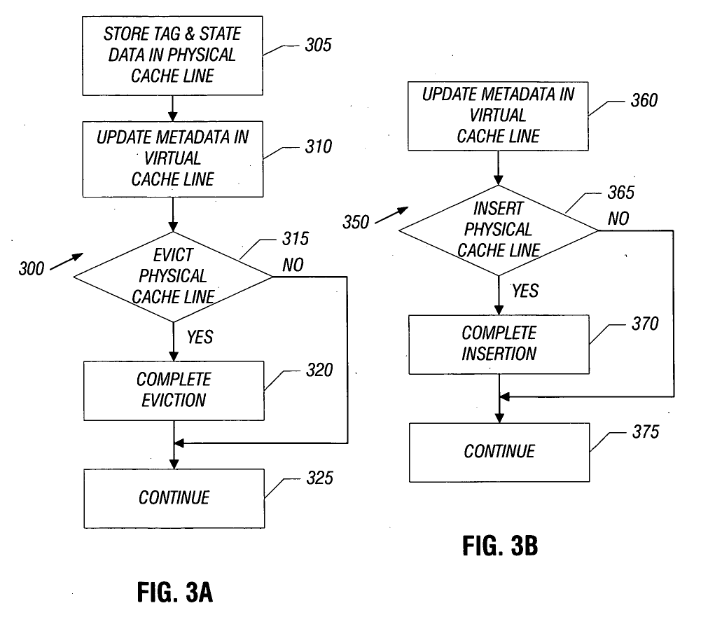

Referring now to FIG. 3A, an algorithm 300 may be implemented in software and may be stored in a medium such as a system memory 70, a disk cache 80, or in a disk drive 90, of FIG. 1. Additionally, algorithm 300 may be implemented in hardware such as on the disk cache 80 of FIG. 1. The physical cache line 240 of FIG. 2 may store cache line tag 242 and cache line state 244 data, as illustrated in block 305. Similarly, virtual cache line metadata may be stored in the virtual cache line 200 of FIG. 2 as illustrated in block 310. The metadata may include various physical and virtual counts or other relevant statistics. These counts and statistics may include, for example from FIG. 2, a physical cache hit count 214, a physical cache evict count 218, a virtual cache hit count 216, a virtual cache evict count 220, or virtual cache LRU 222. Other counts or statistics may also be stored in the virtual cache line 200.

In diamond 315, any one of a number of eviction policies using the virtual and physical metadata may be implemented to determine whether or not to evict the physical cache line. For example, a single count such as the virtual cache hit count or the virtual cache evict count may be used as the eviction policy. In one embodiment, a virtual cache allows for more sophisticated policies that take into account the number of times a cache line has been inserted into the physical cache 240 and/or the number of cache hits over a larger time period. In another embodiment, an eviction policy might include the last access time multiplied by a variable plus the physical evict count multiplied by a second variable, to determine if a physical cache line should be evicted. The variables can be selected to implement different eviction policies. In another embodiment, eviction policies may be modified in response to different system environments, such as operating on battery power in a notebook computer environment.

If the eviction policy of diamond 315 suggests that the eviction be executed, then the cache line is evicted from the physical cache, as illustrated in block 320. Then the process continues as illustrated in block 325 to the next relevant cache line. If the eviction policy that is implemented in diamond 315 suggests that a physical cache line should not be evicted, then the process would continue as indicated by block 325.

Referring now to FIG. 3B, an algorithm 350 may be implemented in software and may be stored in a medium such as a system memory 70, a disk cache 80, or in a disk drive 90, of FIG. 1. Additionally, algorithm 350 may be implemented in hardware such as in the disk cache 80 of FIG. 1. In one embodiment, metadata may be stored in a virtual cache line in anticipation of inserting a cache line into a physical cache line as illustrated in block 360. The virtual cache line may include a cache line tag 210 of FIG. 2 and a cache line state 212 of FIG. 2. The information may also include, for example, a physical cache hit count 214, a virtual cache hit count 216, or a physical cache evict count 218, a virtual cache evict count 220. The information may also include a virtual cache least recently used data 222. It will be understood by persons skilled in the art that other counts or statistics may also be stored in the virtual cache line 200.

The stored metadata in the virtual cache line may be used to implement a physical cache line insertion policy, as illustrated in diamond 365. For example, an insertion policy may be to not insert a cache line into the physical cache until a virtual cache hit count 216 of FIG. 2 has exceeded a threshold. For another example, the insertion policy may take into account the physical cache eviction count 218 of FIG. 2 multiplied by a variable and a virtual cache hit count 216 of FIG. 2 multiplied by a second variable. Virtual cache lines that have high physical cache eviction counts 218 may cause insertion sooner than virtual cache lines that do not have high physical cache eviction counts 218. By using various counts or statistics, insertion policies may be optimized for highest performance, in one embodiment.

If a particular insertion policy suggests that the cache line should be inserted, the insertion is completed as illustrated in block 370. The process continues to the next cache line as shown in block 375. Alternatively, if the cache policy suggests that the insertion should not be completed, then the process continues to the next cache line as indicated in block 375.

In embodiment of this invention, virtual cache may be used to maintain data integrity despite errors by maintaining two system memory resident copies of metadata that describe the content of the cache. This may allow system 10 of FIG. 1 to maintain the consistency of the cached information even in the presence of device (disks or cache) errors. This may also allow multiple requests to be serviced in parallel to take full advantage of the multiple devices.

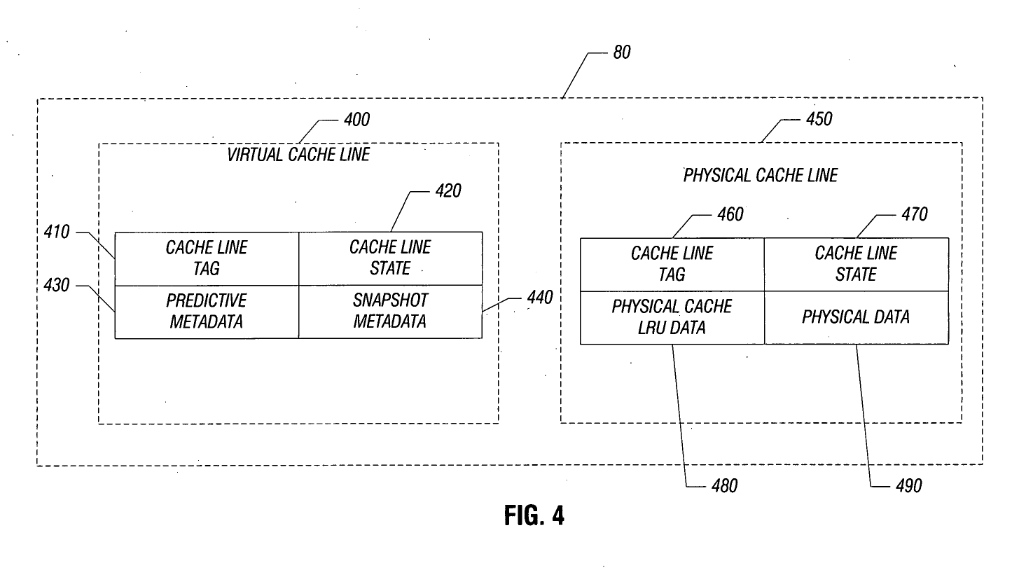

Referring to FIG. 4, in an algorithm for maintaining data integrity despite device errors using virtual cache in accordance with another embodiment of the present invention is disclosed. The virtual cache line 400 includes a cache line tag 410 and a cache line state 420. In this embodiment of virtual cache, virtual cache line 400 may include predictive metadata 430 and snapshot metadata 440. In one embodiment, virtual cache line tag and state data may be stored in non-volatile memory and predictive and snapshot metadata may be stored in volatile memory. In one embodiment, the predictive metadata 430 reflects the cache state of all issued operations including operations that are in the process of being executed. In certain embodiments, the predictive metadata 430 may allow the system 10 of FIG. 1 to make decisions about handling subsequent requests based on the assumption that all outstanding requests will complete successfully. This may allow multiple requests to be serviced in parallel and may take full advantage of multiple devices. Snapshot metadata 440 may reflect only the state of successfully completed operations and can be used to rollback the effects of any operation that does not complete successfully. For example, a cache line may contain tag A data. An operation may be planned which will replace the cache line tag A data with tag B data. The predictive metadata 430 may have tag B metadata in its corresponding cache line reflecting the planned operation as if it has been completed. Conversely, the snapshot metadata 440 may have tag A metadata reflecting the current state.

The snapshot metadata may be identical to its corresponding predictive metadata except for those cache lines that will be changed by currently outstanding requests. At any given time, this may be a small percent of the total cache lines. In one embodiment, a further optimization is to save space by recording only the difference between the predictive and snapshot metadata.

In one embodiment, the physical cache line 450 may include a cache line tag 460, a cache line state 470, the physical cache least recently used (LRU) data 480 and the physical data 490. The cache line tag 460 may be used to identify a particular cache line to its corresponding data on a disk drive. The cache line state 470 may correspond to data that may be useful for determining if the physical cache line should be evicted. The physical cache LRU data 480 may be used to determine when this cache line was last used, which may be useful for determining if the cache line should be evicted. The physical cache line 450 may also include physical data 490 that is associated with this cache line.

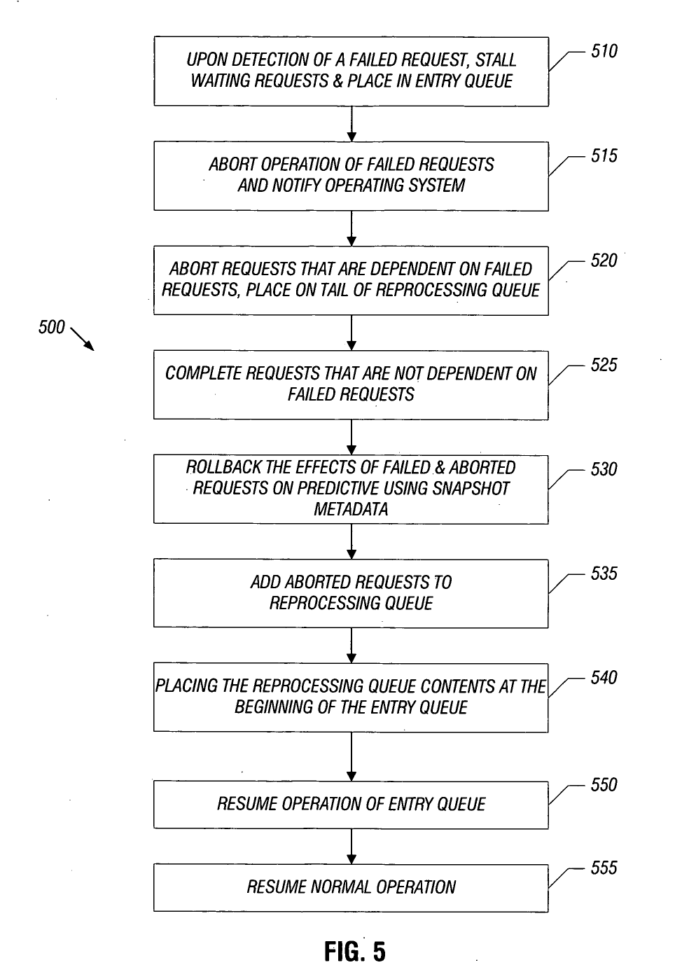

Referring to FIG. 5, an algorithm 500 may be implemented in software and may be stored in a medium such as a system memory 70, a disk cache 80, or in a disk drive 90, of FIG. 1. Additionally, algorithm 500 may be implemented in hardware such as on the disk cache 80 of FIG. 1. In one embodiment, the predictive metadata 430 and snapshot metadata 440 may be used to maintain data integrity despite device errors and even in an environment where multiple requests are serviced in parallel. When a failed request is detected, all requests that are queued waiting for their execution to be planned are stalled including an entry queue, as illustrated in block 510. An entry queue is a queue that is used to process incoming data requests in sequential order. In block 515, the operations of a failed request are aborted and the operating system may be notified of the failed request. The requests that are dependent on failed requests are aborted and placed on the tail of a newly created reprocessing queue, as indicated in block 520. The requests that are not dependent on failed requests are allowed to finish and are therefore completed, as indicated in block 525.

For both failed and aborted requests, a cache policy manager may rollback the effects of the failed and aborted requests on the predictive metadata 430, as illustrated in block 530. To facilitate this, a cache controller may maintain the snapshot metadata 440. The snapshot metadata may not be updated predicatively but rather updated only on successful completion of requests. In the case of an aborted operation, the cache policy manager may set the predictive metadata 430 equal to the snapshot metadata 440 for the affected cache lines. Since the entry queue is stalled, eventually all outstanding requests will either fail, complete successfully or be placed on the reprocessing queue. In block 535, the aborted requests are added to the reprocessing queue. The reprocessing queue can now be combined with the entry queue by placing the reprocessing queue contents at the beginning of the entry queue, so that they are prioritized higher over other requests that may have come later. The reprocessing queue may be left empty after the combining.

In the case of a failed operation, when there is a chance of data loss or corruption, then the location and impact of the failure is reported. It is possible that the failed operation corrupted the cache version of data. For example, an unsuccessful write may have left the cache line containing garbage. For some nonvolatile cache hardware, even an unsuccessful read may have left the cache line containing garbage. In these examples, the cache controller does not know the state of the cache line and it cannot simply rollback the state using the snapshot metadata. Instead, it may report its uncertainty about the state of the cache line so that the predictive metadata will not be consulted for these cache lines as indicated in block 515. The failed operation may be recorded to a bad block list when the cache line is unusable. Therefore, the cache driver may not allocate any data to a cache line that is in the bad block list. If the failed operation occurred in a cache line that was incoherent (dirty), then the failure may also be reported on a bad tag list to identify which data on the disk drive logical block address has been contaminated. Therefore, if an attempt is made to read data that is on the bad tag list, the data may not be returned and the request may fail.

After the failed operations are reported, the processing of operations can continue for the entry queue, as indicated in block 550. When the entry queue is cleared, normal operations can resume, as indicated in block 555. A write to a tag that is on the bad tag list may remove the tag from the bad tag list, and allow subsequent reads to the same tag to proceed normally.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising rolling back a failed write request to a cache to a previous state using snapshot metadata.

2. The method of claim 1 further comprising inserting a request into a reprocessing queue and adding the contents of said reprocessing queue to the beginning of an entry queue.

3. The method of claim 1 further comprising reprocessing aborted requests.

4. The method of claim 3 further comprising joining a reprocessing queue to an entry queue.

5. The method of claim 1 further comprising reporting failed operations.

6. The method of claim 5 further comprising identifying failed cache lines on a list.

7. The method of claim 5 further comprising identifying failed dirty cache lines on a list.

8. The method of claim 1 further comprising maintaining said snapshot metadata only for metadata which is different from a predictive metadata.

9. An article comprising a medium storing instructions that, if executed, enable a processor-based system to restore a failed write request to a cache to a previous state using snapshot metadata.

10. The article of claim 9 further storing instructions that, if executed, enable a processor-based system to reprocess aborted requests.

11. The article of claim 10 further storing instructions that, if executed, enable a processor-based system to join a reprocessing queue to an entry queue.

12. The article of claim 9 further storing instructions that, if executed, enable a processor-based system to report the failed write request.

13. The article of claim 9 further storing instructions that, if executed, enable a processor-based system to reprocess aborted requests.

14. The article of claim 9 wherein said cache further comprises a polymer memory.

15. The article of claim 9 wherein said cache further comprises ferroelectric polymer memory.

16. The article of claim 9 wherein said cache further comprises dynamic random access memory.

17. The article of claim 9 wherein said cache further comprises a flash memory.
